(19) United States
(12) Patent Application Publication
(10) Pub. No.: US 2026/0017443 A1
(43) Pub. Date: Jan. 15, 2026

(54) System and Method for Autonomously Designing Process Systems for Semiconductor Manufacturing through Reinforcement Learning

(71) Applicant: Yang Pan, SINGAPORE (SG)

(72) Inventor: Yang Pan, SINGAPORE (SG)

(73) Assignee: Inspiring Atoms Pte Ltd, SINGAPORE (SG)

(21) Appl. No.: 18/771,831

(22) Filed: Jul. 12, 2024

(51) Int. Cl. G06F 30/398; G06F 119/18

(52) U.S. Cl. CPC G06F 30/398; G06F 2119/18

(57) ABSTRACT

Disclosed herein are systems and methods for autonomously designing process systems for semiconductor manufacturing using subsystem and system digital twins. An artificial intelligence (AI) engine of an AI machine is utilized to explore a large process recipe parameter space and identify optimal process recipes through a reinforcement learning approach, leveraging a policy neural network and Monte Carlo tree search (MCTS) program. The AI engine also identifies performance bottlenecks and mitigates them by redesigning the responsible subsystems within the process system.

### FIELD OF THE INVENTION

The present invention relates to methods and systems for autonomously designing process systems for semiconductor fabrication. Specifically, the invention employs reinforcement learning (RL) algorithms in conjunction with system digital twins to optimize the design and evaluation of semiconductor process systems. This approach enables the search for optimized process recipes in a large recipe parameter space, establishing the intrinsic capabilities of the process systems in a virtual environment. By dramatically reducing design time and increasing confidence in new designs, this invention addresses the challenges associated with traditional process system design.

### BACKGROUND OF THE INVENTION

The semiconductor industry requires the development of highly precise and efficient process systems to fabricate integrated circuits and other microelectronic devices. These systems must perform complex steps such as etching, deposition, and other critical processes with high precision and consistency. Traditionally, designing and optimizing these process systems has been a labor-intensive and time-consuming task, often taking several years and relying heavily on expert knowledge and extensive experimentation.

A significant challenge in traditional process system design is the uncertainty in whether the designed system will meet performance expectations. This uncertainty arises from the inability to fully predict and evaluate the system's capabilities during the design phase, leading to potential delays and increased costs.

Advancements in artificial intelligence (AI) and machine learning (ML) offer new opportunities to address these challenges. Reinforcement learning (RL), a subset of ML, has shown significant potential in optimizing complex systems by learning from interactions and feedback. When combined with digital twins-virtual replicas of physical systems-RL can simulate and evaluate process systems in a virtual environment, enabling accurate modeling and optimization of system designs.

The integration of RL algorithms with system digital twins enables the exploration of a large recipe parameter space to find optimized process recipes. This capability allows for the establishment of the intrinsic capabilities of the process system in a virtual world, providing valuable insights that are difficult to achieve through traditional methods.

The present invention addresses the need for more efficient and reliable process system design by leveraging RL algorithms and system digital twins. This novel approach not only reduces the time required for system design but also increases the confidence in new designs by thoroughly evaluating their capabilities in a virtual environment. By mitigating the uncertainty and extensive time commitment associated with traditional design methods, this invention enhances the precision, reliability, and overall effectiveness of semiconductor fabrication processes.

### SUMMARY

The present invention provides systems and methods for autonomously designing semiconductor process systems using reinforcement learning (RL) algorithms in conjunction with system digital twins. This approach addresses significant challenges in conventional process system design, such as lengthy development times and uncertainty in system performance.

In some embodiments, an AI engine includes a system digital twin with subsystem digital twins for simulating substrate progression in a vacuum process chamber. The AI engine may be a software module of an AI machine. An RL engine leverages a policy neural network and a Monte Carlo tree search (MCTS) program to autonomously generate process recipes. By iteratively refining and optimizing the policy neural network through simulations, the AI engine can establish a process recipe that reflects the intrinsic capabilities of the process system in a virtual environment.

The process begins with an RL agent generating a process recipe. If a process recipe that meets the desired specifications cannot be generated, a design agent analyzes the generated recipe parameters against their limits defined by the parameter ranges. This helps identify performance bottlenecks within the system and the subsystems. For example, if a recipe parameter consistently hits its limit, the design agent identifies this as a bottleneck. The design agent then autonomously redesigns the subsystems responsible for the bottlenecks to increase the parameter ranges. This may involve employing a trained neural network to generate new design parameters or select alternative subsystem architectures. By adjusting the design parameters or selecting new subsystem architectures, the process system's capabilities are enhanced, allowing the RL algorithm to explore a broader parameter space.

The invention significantly reduces the time required to design new process systems. By leveraging RL and digital twins, the design agent can evaluate the performance of the system in a virtual world, increasing confidence in the new design before physical implementation. This virtual evaluation ensures that the system will meet performance expectations, reducing the risk of costly redesigns and delays.

Additionally, the invention incorporates mechanisms to balance exploration and exploitation during the RL process. In this context, parallel computation capabilities sourced from the AI machine become critically important. Techniques such as assigning random initial weights to the policy neural network or employing &-greedy algorithms ensure that the RL process does not become trapped in local optima, leading to more robust and comprehensive design solutions. Parallel computing improves efficiency in searching for a solution within a large process recipe parameter space.

Furthermore, the AI engine includes a subsystem design library with architecture options for subsystems, allowing for flexible and adaptive design modifications. This library can include digital twins of various RF power generators, vacuum pumps, and resonators, among others. The invention also includes a system specification generator for identifying ranges of selected recipe parameters based on subsystem architecture and design parameters. This generator may utilize Monte Carlo simulations to determine these ranges accurately.

Overall, this invention transforms the conventional process system design approach by reducing development time, increasing design confidence, and optimizing system performance through advanced AI techniques and virtual simulations. By enabling a thorough evaluation of process system capabilities and proactively addressing bottlenecks, the invention ensures more efficient and effective semiconductor process system design.

### BRIEF DESCRIPTION OF THE DRAWINGS AND TABLES

The following brief descriptions relate to the accompanying drawings, which serve to enhance the clarity and understanding of the present disclosure:

FIG. 1: Illustrates a diagram of an exemplary process system.

FIG. 2A: Depicts a functional diagram of an AI machine configured to autonomously design a process system.

FIG. 2B: Depicts detailed functional blocks of the AI engine.

FIG. 3: Presents a schematic representation of a system digital twin.

FIG. 4: Portrays a neural network representation for the system digital twin.

FIG. 5: Displays a process flow example using ALE, mapped for the RL processes for autonomously generating a process recipe.

FIG. 6A: Shows a schematic representation of a policy neural network, integral to the RL process.

FIG. 6B: Illustrates a schematic representation of a system specification generator based on subsystem architecture options and design parameters.

FIG. 6C: Showcases a schematic representation of a neural network assisting in the process system design.

FIG. 7: Reveals a schematic diagram of an exemplary algorithm for RL, utilizing an MCTS program to autonomously generate a process recipe.

FIG. 8: Illustrates a flowchart describing the generation of a process recipe through RL.

FIG. 9: Showcases a flowchart describing a process for autonomously designing a process system.

Table 1: Outlines design parameters describing subsystem structures and topologies.

Table 2: Summarizes parameters that describe structures pre- and post-processing, using ALE process as an example.

Table 3: Showcases selected ALE process recipe parameters, discretized into levels suitable for implementing RL.

### DETAILED DESCRIPTIONS

This section delves into the specific embodiments of the present invention, aiming to provide a comprehensive understanding. It is important to note that while certain implementations are described to illustrate the inventive aspects clearly, any alterations and modifications that fall within the scope of the appended claims are intended to be encompassed by this disclosure. These detailed descriptions underscore the innovative features of the invention, setting it apart from existing technologies.

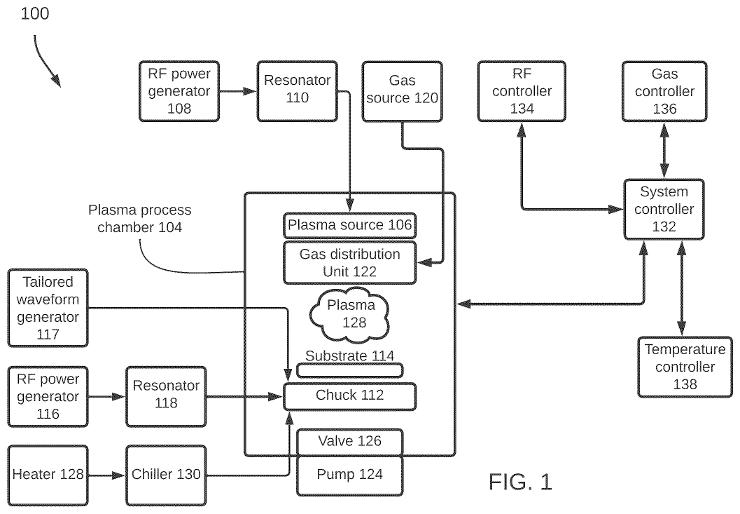

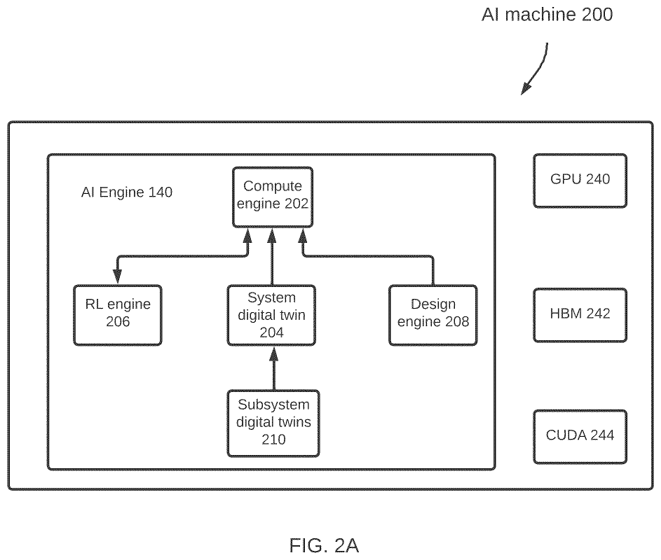

FIG. 1 illustrates an embodiment of a process system, designated as 100. The process system is generic for plasma-enhanced etching or deposition processes. For example, the process system 100 can be employed for reactive ion etching (RIE) or atomic layer etching (ALE). It can also be utilized for plasma-enhanced chemical vapor deposition (PECVD) or atomic layer deposition (ALD). In some cases, subsystems related to plasma generation may be removed, converting the process system 100 into a thermal process system. The inventive concept presented herein is generic and can be applied to any type of semiconductor process system. The plasma-based process system with a vacuum chamber is used for illustration only and should not limit the scope of the inventive concept.

The process system 100 includes a plasma process chamber 104, constructed to maintain a vacuum suitable for plasma processing. Within this system, a plasma source 106 is situated to receive radio frequency (RF) power from an RF power generator 108 via a resonator 110. The plasma source 106 may be realized in various configurations, such as an inductively coupled plasma (ICP) source or a transformer coupled plasma (TCP) source, among others.

The RF power generator 108 can operate at single or multiple frequencies—for instance, 13.56 MHz, 2.0 MHz, and 40 MHz may be used. The role of the resonator 110 is to match the output impedance of the RF power generator 108 with the impedance of the plasma process chamber 104, considering the impedance characteristics of the transmission lines. This resonator 110 typically comprises inductors and capacitors and may include mechanically adjustable capacitors. Alternatively, in other embodiments, the resonator 110 might exclude mechanically adjustable capacitors.

Impedance adjustments may be realized by varying the operating frequencies of both the RF power generator 108 and the resonator 110. During a process, the plasma is likely to exhibit variable states, which present different impedance levels. To maintain efficient energy transfer and minimize power reflection from the plasma process chamber 104 back to the resonator 110, it may be necessary to fine-tune the frequency for each distinct state of the plasma to ensure the resonator 110 remains in a resonating condition.

The plasma process chamber 104 is further outfitted with a chuck 112 that supports a substrate 114. The chuck 112 can be designed as an electrostatic chuck (ESC) or a vacuum chuck, depending on the process requirements. When an ESC is utilized, the chuck 112 is electrically connected to an RF power generator 116 via a resonator 118. Like resonator 110, resonator 118 requires tuning to a resonating state by adjusting its operating frequency. The operating frequencies of RF power generator 116 may differ from those of RF power generator 108. For instance, generator 116 may operate at a substantially lower frequency than generator 108. The RF power generator 116 provides a bias to the chuck 112. This bias is delivered through a blocking capacitor, which, while not depicted, is standard in the field. Alternatively, a tailored waveform generator 117 may be employed to supply a bias to the chuck 112. The tailored waveform can significantly narrow the distribution of ion energies produced by the ignition of plasma 128 within the process chamber 104. Depending on the implementation, the tailored waveform generator 117 may be connected to the chuck 112 alone or in conjunction with the RF power generator 116 and resonator 118 to provide the required bias.

The operation of the RF subsystem, including the RF power generators, resonators, and plasma source, is managed by an RF controller 134. This controller communicates with and is subordinate to a system controller 132.

The plasma process chamber 104 incorporates a gas distribution unit 122, tasked with delivering process gases from a gas source 120 into the chamber. The gas distribution unit 122 can take various forms, such as a gas injector or a showerhead, and may include a side injection feature near the inner surfaces of the chamber body. The gas source 120 typically draws from a facility's gas supply through a gasbox and uses a combination of valves, pressure regulators, and mass flow controllers (MFCs) to regulate the gas flow into the chamber. In some other implementations, precursor delivery systems for delivering a precursor in gas, liquid, or even in solid state may also be employed (not shown in the figure).

Additionally, the plasma process chamber 104 houses a pump 124, which may be a turbomolecular pump or another suitable type, designed to evacuate gases and by-products from the chamber. A valve 126, generally positioned atop the pump 124, modulates the evacuation rate from the chamber. The chamber pressure is monitored by a manometer (not illustrated), which triggers adjustments to the set point of an actuator of the valve 126 to maintain a constant pressure suitable for a vacuum-based process.

The gas distribution subsystem, which includes the gas distribution unit 122, gas source 120, pump 124, and valve 126, is overseen by a gas controller 136. This controller is connected to the overarching system controller 132, ensuring integrated management of the process system 100.

The plasma process chamber 104 is also equipped with a temperature control subsystem to maintain the desired thermal conditions for the substrate and the chamber. In the embodiment exemplified in FIG. 1, the temperature of the chuck 112 is regulated by a temperature controller 138, which operates a heater 128 and a chiller 130, as well as a temperature sensor (not depicted). The chuck 112 may be designed with multiple zones, each maintained at a distinct temperature. Additionally, temperature control for other components within the process chamber, such as the gas distribution unit 122 and various chamber surfaces, may be required and is implemented as is common in the industry. The temperature subsystem is controlled by a temperature controller 138 coupled to the system controller 132.

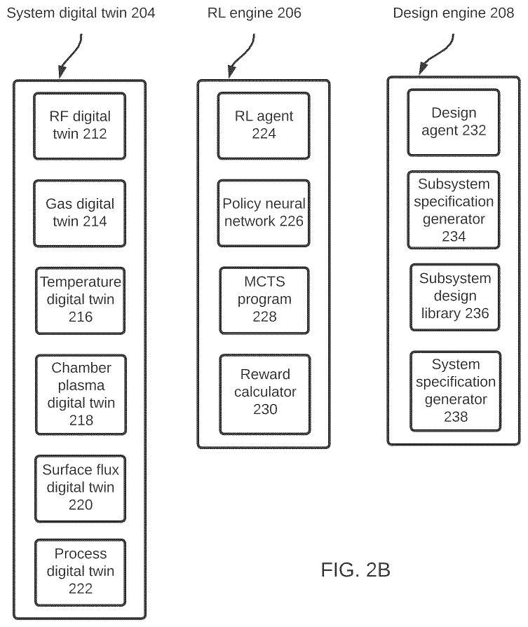

FIG. 2A showcases an embodiment of the AI machine 200. In one implementation, the AI machine is a computer optimized for AI applications through advanced hardware and software modules. The hardware module includes advanced chips like a graphics processing unit (GPU) 240 and high-bandwidth memory (HBM) 242. These components are integrated using advanced packaging technologies to achieve the very high bandwidth required for AI applications. The software modules further include Compute Unified Device Architecture (CUDA) 244. These hardware and software modules enable the AI machine 200 to conduct highly efficient parallel computing, such as the algorithms used for reinforcement learning (RL).

The AI machine 200 also includes an AI engine 140, which enables autonomous operations for designing the process system. The AI engine 140 is typically implemented as software comprising a compute engine 202, which controls its operations. The AI engine 140 further includes an RL engine 206 responsible for autonomously generating a process recipe through RL by leveraging a system digital twin 204, which replicates the operations of the process system in a virtual environment. Additionally, the AI engine 140 includes a design engine 208 responsible for identifying performance bottlenecks in the process system 100 and recommending design changes to enhance its capabilities. The compute engine 202 coordinates the operations of the RL engine 206 and the design engine 208 by leveraging the system digital twin 204. The system digital twin 204 includes subsystem digital twins 210.

FIG. 2B depicts more detailed functional blocks of the AI engine 140. The system digital twin 204 comprises an RF digital twin 212 for simulating the operations of the RF subsystem, a gas digital twin 214 for the gas subsystem, and a temperature digital twin 216 for the temperature subsystem. The system digital twin 204 further comprises a chamber plasma digital twin 218, a surface flux digital twin 220, and a process digital twin 222. The details of these subsystem digital twins will be discussed in the following sections.

The RL engine 206 further includes an RL agent 224, which is typically a software program stored in a storage medium of the compute engine 202 for executing an RL process for autonomous process recipe generation. A policy neural network 226 and an MCTS program are employed by the RL agent 224 to build a search tree and to learn by evaluating actions against rewards. The rewards are calculated by a reward calculator 230 for each completed simulated case using the system digital twin 204.

The design engine 208 further includes a design agent 232, which is a software program stored in the storage medium of the AI engine 140. The design agent 232 works with the RL agent 224 to generate recommended design changes for the process system if a process recipe cannot be created to meet an output specification after an extensive search in a recipe parameter space. The design engine 208 further includes a subsystem specification generator 234 and a system specification generator 238 for generating output parameters and their ranges, based on the design architectures and parameters of the subsystems. The design engine 208 also includes a subsystem design library 236, which is an important part of the design engine. The subsystem design library encompasses design options for the subsystems. For example, it may include digital twins of various RF power generators that deliver different ranges of the RF power at designated RF frequencies. The RF power generators may be supplied by different manufacturers. In another example, the design library may include a list of resonators tuned to different resonating frequencies at different operating power levels. It may further include various designs of RF power amplifiers with different components and architectures.

For the gas subsystem, the design library may include different types of vacuum pumps, from rough pumps to turbomolecular pumps with different capacities and operating ranges.

When performance bottlenecks are encountered by the RL agent 224, the design agent 232 can investigate the design library and evaluate different design parameters or architecture options. For example, if uniformity performance is short of the specification because of a gas injection issue, the design agent 232 can evaluate design options to replace a gas injector with a showerhead. The design agent may change the injection patterns by altering locations of holes in the injector or the showerhead. The subsystem and system digital twins can be employed together with the RL agent 224 to investigate if a process recipe can be established with new designs to meet the output specification by initiating a new RL process.

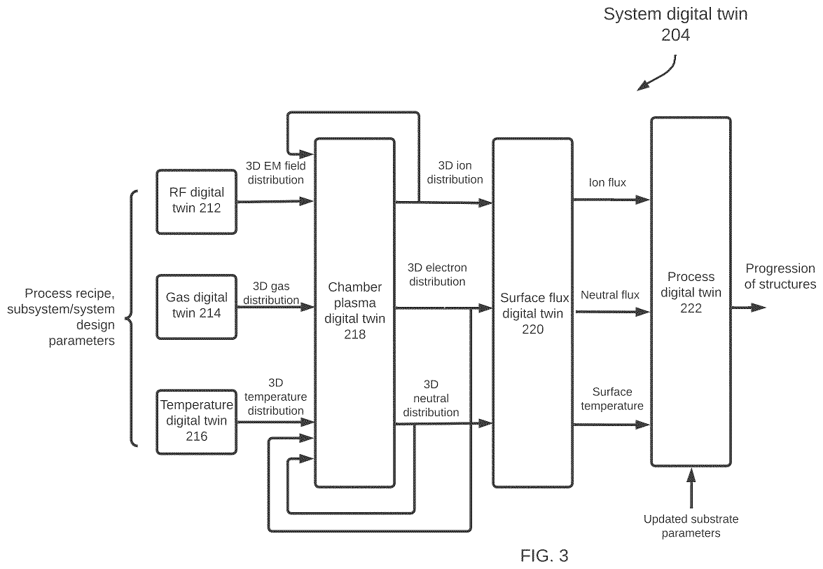

FIG. 3 illustrates schematically a flow diagram of the system digital twin 204. The RF digital twin 212, the gas digital twin 214, and the temperature digital twin 216 take related process recipe parameters and subsystem and system design parameters as their inputs. The RF digital twin 212 is designed to simulate the RF subsystem, which includes at least RF power generators and resonators. In some cases, it may also include a tailored waveform generator for the bias, although the tailored waveform generator is typically not operated in the RF range. In one implementation, the RF digital twin 212 includes a SPICE model for the RF circuits, which determines the RF power deposited into the plasma source during a time step. A Maxwell's equation solver is subsequently employed to compute the electromagnetic (EM) field distribution inside the chamber, considering the chamber structure parameters.

The RF digital twin 212 receives recipe parameters like RF power and initial operating frequency for the step stipulated by the process recipe. A set of system and subsystem design parameters, such as RF circuit topology, values of each component, structures, and parameters of the plasma source, and chamber structure parameters, are typically stored in a storage medium of the compute engine 202. A set of exemplary design parameters for the RF subsystem is listed in Table 1. The RF digital twin 212 can be used to determine the resonating frequencies of the RF subsystems. In another embodiment, more than one RF digital twin may be used. For example, the plasma source and the chuck bias may be modeled by different RF digital twins.

Similarly, the gas digital twin 214 replicates functions of the gas distribution subsystem, encompassing elements like the gas source 120, the gas distribution unit 122, the pump 124, the valve 126, and the manometer (not pictured).

The gas digital twin 214 receives process recipe parameters like the flow rates of process gases. For example, for an ALE process, the gas digital twin 214 receives the flow rate for the first and second process gases and the chamber pressures for the surface modification step and the sputtering step, respectively. The design parameters for the gas delivery systems include the design parameters for the gas distribution unit as listed exemplarily in Table 2. If it is a showerhead, the design parameters will include its size, volume, distribution of injection channels/holes, and their sizes. The shape and size of the plasma process chamber are also important input parameters for the gas digital twin 214. The output of the gas digital twin 214 includes three-dimensional (3D) gas distribution (e.g., density, partial pressure, velocity, and residence time) inside the gas distribution unit 122 and in the plasma process chamber 104. In some implementations, the gas distribution along gas lines from the gas source 120 to the entry of the gas distribution unit 122 will also be modeled. The gas distribution can be simulated using methods based on the fluid dynamics by leveraging finite element techniques or other advanced computational techniques.

The temperature digital twin 216 mirrors the temperature control subsystem, which includes the heater 128, the chiller 130, and temperature sensors (not pictured). Besides the chuck temperature controls, it may additionally incorporate temperature regulation for other chamber parts such as the gas distribution unit 122.

The temperature digital twin 216 receives process recipe parameters like chuck temperatures at different steps. In some cases, the chuck 112 may be divided into zones, each with a different temperature specified by a process recipe. The input parameters to the temperature digital twin 216 further include design parameters for the heater and chiller as shown exemplarily in Table 2. For the heater 128, the design parameters include its locations inside the chuck or other chamber parts, as well as a range of its operating power. The design parameters further include thermal conductivity for various materials and their interfaces. For the chiller, the design parameters may include the type of coolants, flow rates of the coolants, and the number and locations of conduction channels. The temperature digital twin may apply numerical simulation methods like the finite element method to simulate the temperature distribution of the chuck, substrate surface, and inner surface of the plasma process chambers.

It should be noted that treating the digital twins 212, 214, and 216 independently may oversimplify the real world. For example, the RF power deposited into the chamber may affect the temperature of the substrate surface. Some of these interactions among different subsystem digital twins should be considered carefully.

The subsystem digital twins listed herein are exemplary only. In some process systems, digital twins for modeling interior chamber surface aging are also important for predicting accurately structure progression undergoing a process. In some other cases, erosion of edge rings along the edge of an ESC can also be an important factor which requires a different digital twin to improve the accuracy of the prediction. Therefore, the subsystem digital twins listed herein are elaborate but not exclusive.

The outputs of the subsystem digital twins feed into the chamber plasma digital twin 218. During a specific time step of a process, the chamber plasma digital twin 218 models the plasma inside the chamber 104 and outputs 3D distributions of electrons, ions, and neutrals. The distributions at a specific time are a function of the EM field, gas, and temperature at that moment, as well as the distributions of electrons, ions, and neutrals prior to that moment. Therefore, the distributions of the electrons, ions, and neutrals need to be determined in a recurring manner. As shown in FIG. 3, the outputs of the chamber plasma digital twin from the current time step can serve as inputs for the same digital twin for the next time step. Each simulation event is for a predetermined time step defined by the compute engine 202 based on the process recipe.

After the 3D distributions of ions and neutrals are known, the surface flux digital twin 220 calculates and outputs the ion flux and neutral flux toward the surface of the substrate. Additionally, the digital twin 220 may output the surface temperature of the substrate by working together with the temperature digital twin 216. The plasma sheath above the substrate is critically important for determining the ion flux, which greatly impacts the etching behavior. The formation of the plasma sheath is well understood in the art and can be modeled accurately using the chamber plasma digital twin 218.

The outputs of the surface flux digital twin 220 feed into the process digital twin 222 to simulate the process in the plasma process chamber 104. The state of the substrate structures serves as the inputs to the process digital twin 222. The current state of the substrate parameters is used by the process digital twin 222 to determine its outputs.

The flow depicted in FIG. 3 represents a snapshot of the process during the time step in the plasma process chamber 104. Therefore, the output of the process digital twin is a progression of the structures during the time step.

During each time step, the accumulated ion and neutral fluxes should be counted. Details of ion and neutral distribution are important for the process in the plasma process chamber. For ions, their energy and angular distributions during the step are critically important and can vary based on location on the surface of the substrate. The outputs of the surface flux digital twin 220 should include such critical details. Similarly, for neutrals, the density, thermal energy, and activation energy are important parameters for the substrate surface undergoing the process.

It should be noted that the designs of the subsystem, chamber plasma, and the process digital twins are exemplary herein. There could be many variations in implementation strategies. In some implementations, the chamber plasma digital twin and the surface flux digital twin could be combined into a single digital twin. In other implementations, the surface flux digital twin may be combined with the process digital twin. Additionally, the RF subsystem digital twin may be broken down into several digital twins to represent the plasma source and the bias units separately. Similarly, the temperature digital twin can be divided into two or more digital twins, with at least dedicated digital twins for the chuck and the gas distribution unit, respectively. All such variations are obvious and should fall within the inventive concept of the present inventions.

Implementations of the digital twins by neural networks can follow the same strategy of dividing the process system into subsystems.

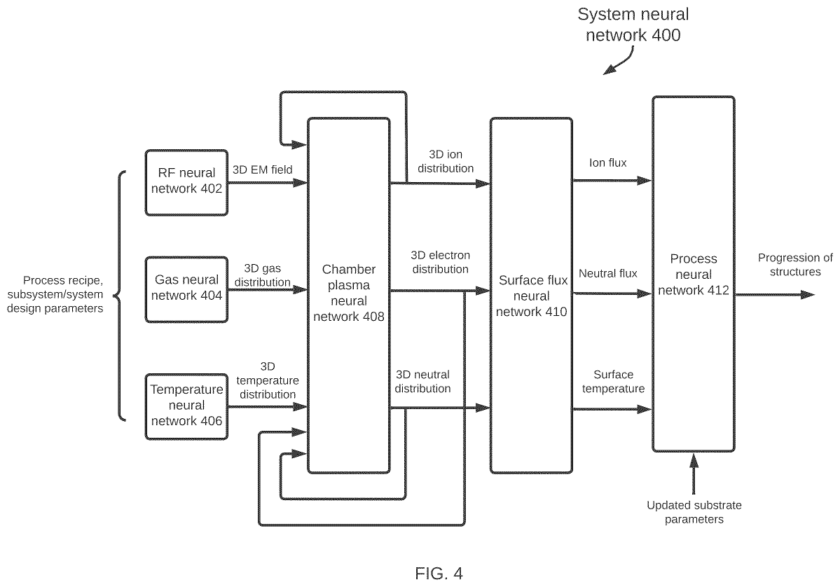

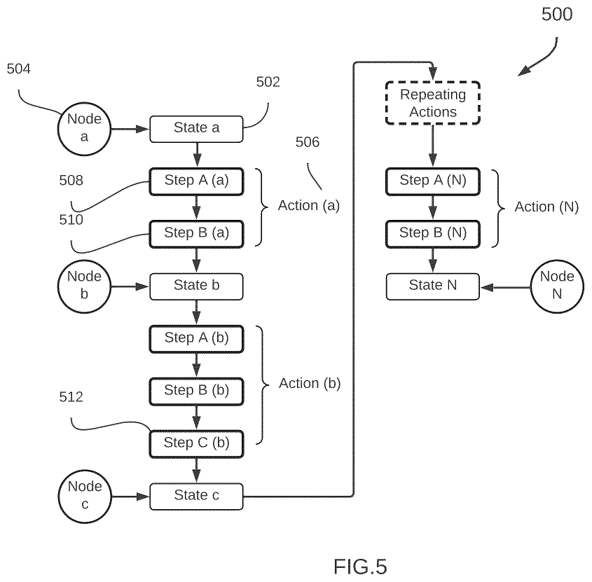

FIG. 4 illustrates an exemplary process system represented as a system neural network 400. In this embodiment, the subsystem digital twins are reconstructed using various neural networks. The RF digital twin 212 serves as the basis for training the RF neural network 402. Using the plasma source 106 attached to the RF power generator 108 and the resonator 110 as an example, one can begin by constructing a SPICE model to simulate the RF power generator 108 and resonator 110, including transmission lines effects. The SPICE model outputs an initial AC current and voltage for the coils of the plasma source 106, necessitating an assumed initial impedance for the plasma 128. Following this, a numerical simulator applies Maxwell's equations to predict the EM field distribution within the plasma process chamber 104.

The wealth of simulation data generated by the RF digital twin 212 becomes the training set for the RF neural network 402. The inputs for the neural network 402 include RF circuit topology and parameters such as the values of the inductors, capacitors, resistors, and transistors within the generator and resonator, along with detailed modeling of effects and transmission lines. In one implementation, types of RF power amplifier may be indexed as an input of the neural network 402. For a fixed circuit topology, the components may also be indexed. Additional parameters that characterize the plasma source, like its size, position, resistivity, inductance, and the number of coil turns, are also incorporated.

Furthermore, the RF neural network 402 considers the chamber structure parameters dimensional specifics, positions of the chuck and the gas distribution unit, and material properties of these components, as listed exemplarily in Table 1. Some parameters are measurable and thus provide a more substantial weight during the training of the RF neural network 402. For instance, sensors might track the current and voltage alterations in the coils or the reflected power at the resonator's output node 110. A B-dot sensor with multiple small coils could be positioned within the chamber to map the magnetic field distribution in an experimental setup. The information gleaned from these sensors not only informs the training process but ensures that the RF neural network 402 is closely aligned with the real-world behaviors observed.

Utilizing a neural network for modeling the bias portion of the RF subsystem focuses on the electric field generated initially in response to the applied RF power. Unlike the magnetic field concerned with plasma generation, the bias deals with the electric field affecting the substrate surface.

Transitioning to the gas dynamics within the process system 100, we approach the gas distribution neural network 404, which is informed by the gas digital twin 214. Numerical algorithms based on the fluid dynamics are the foundation for determining the gas distribution within the chamber 104. This complex interplay involves the gas inflow from the gas distribution unit 122, the outflow managed by the pump 124 and the valve 126, which is influenced by the chamber's conductance and volumetric parameters. While numerical simulations offer accuracy, their demand for computational resources and time constraints necessitate a more efficient approach for real-time applications, hence the establishment of the gas distribution neural network 404.

The gas distribution neural network 404 is trained with simulation data reflecting various parameters, including the types and flow rates of gases, the design of the gas distribution unit 122, the pump's capacity 124, and the set point of the actuator of the valve 126, along with chamber dimensions and conductance. Some of the design parameters are listed in Table 1. The gas distribution unit 122 implemented as an injector, a showerhead, or a combination of both can affect the gas distribution in the process chamber 104. The size, quantity, and distribution of channels/holes inside the injector and the showerhead are important design parameters. Gas pressure within the process chamber, monitored by a manometer, provides measurement data that enhances the training of the gas distribution neural network 404, often weighted more significantly than the simulation data to ensure the model's relevance to actual conditions.

Parallel to these developments is the creation of the temperature control neural network 406, drawn from the temperature digital twin 216. This neural network is dedicated to mapping the thermal landscape within the plasma process chamber, particularly at the substrate surface. Its training originates from numerical models that simulate heat interactions and distributions. Inputs for the temperature neural network 406 include chuck and chamber parameters affecting heat generation and thermal conduction. In scenarios involving an ESC, the thermal characteristics of the ESC and the heat conduction efficiency, potentially affected by helium pressure used as a medium, are critical. Additional chamber specifications, such as size and construction materials, also influence the model. Temperature readings from sensors within the chuck 112 and the chamber 104 provide valuable real-world data, which, when used to train the temperature neural network 406, may carry heavier weights over simulated data due to their direct measurement of the physical environment. This balance of simulated and measured data ensures that the various neural networks closely mimic the actual processes, thereby enabling accurate predictions within the process system.

FIG. 4 elucidates the intricacies of the system neural network 400, where the outputs of the subsystem neural networks act as inputs to the chamber plasma neural network 408. The chamber plasma digital twin 218 serves as the foundation for the chamber plasma neural network 408, enabling a sophisticated representation of the plasma within the etching chamber.

To simulate the movement of particles within the plasma, either a Monte Carlo or a numeric plasma simulator can be used to visualize the three-dimensional distribution of electrons, ions, and neutrals. This is crucial because electrons, which are significantly lighter, move more rapidly than ions, leading to the creation of a sheath on the surfaces within the chamber. This sheath plays a pivotal role in ion acceleration toward the substrate, a process essential for sputtering but potentially counterproductive during surface modification.

The training of the chamber plasma neural network 408 integrates simulation data for faster computation and higher efficiency. However, to refine its predictive capabilities, it may also assimilate measurement data gathered from sensors within the chamber, such as optical sensors that detect light emission from neutrals and hairpin sensors that gauge electron density. This measurement data may be given a heavier weight over the simulated data to ensure that the outputs of the plasma neural network 408 are as realistic as possible.

The dynamic nature of the plasma environment is captured by the recurrent neural network (RNN) design of the chamber plasma neural network 408. This means it can process temporal sequences, taking snapshots of plasma conditions at a given time and incorporating them into the model for future predictions. It is an ongoing cycle where the neural network's previous outputs become part of the input data for the next time step, mimicking the continuous evolution of the plasma state.

Once the chamber plasma neural network 408 has computed the 3D distributions, the ion and neutral fluxes to the substrate surface can be determined based on a surface flux neural network 410. The ion and neutral fluxes, along with the surface temperature of the substrate, are then taken as inputs for the process neural network 412. The process neural network 412 can be trained based on the data generated by the process digital twin. The outputs of the process neural network 412 further include the progression of the structure parameters.

Ultimately, the chamber plasma neural network 408 and the surface flux neural network 410 yield valuable outputs beyond just fluxes; they also provide critical insights into the surface temperature by working together with the temperature neural network 406. The accumulated fluxes during the time steps should also include valuable information about ion energy and angular distribution, as well as neutral thermal energy and activation energy. These parameters are essential for fine-tuning the process in the plasma chamber to achieve the desired etching precision and substrate surface quality.

It should be noted that FIG. 4 showcases an embodiment 400 of a full neural network implementation of the system digital twin 204. In other embodiments or implementations, some functional blocks may not be implemented as neural networks. For example, the surface flux neural network 410 may be an analytical model. Hence, embodiment 400 is exemplary. There may be many variants of implementations by combining models, lookup tables, analytical models, numerical models, and Monte Carlo models for selected building blocks of the system digital twin 140. All such variants fall within the scope of the present inventive concept.

An ALE process is employed herein as an example to illustrate a system and method for autonomously generating a process recipe through the application of an RL algorithm. FIG. 5 illustrates an ALE process flow 500, which is suitable for implementing the RL algorithm. An exemplary ALE process typically involves alternating between a surface modification step A and a sputtering step B in a cyclic manner. It should be noted that steps A and B herein are commonly called half cycles of the ALE process, which are different from the steps we discussed previously for simulating plasma behavior in the chamber.

During step A, the surface of the substrate 114 is chemically altered using chemically active neutrals formed in the plasma, which is generated by a plasma source powered by an RF power generator. A halogen gas, such as chlorine, is often introduced to produce neutrals for this purpose. During this surface modification step, the bias to the chuck is typically set to zero to minimize the impact of ions on the substrate, thereby preserving the integrity of the ALE process.

Conversely, during the sputtering step B, an inert gas like argon is introduced to generate energetic ions that physically remove the chemically modified layer from the substrate by sputtering. At this juncture, a bias is typically applied to the chuck through the RF power generator and resonator.

Between these steps, a purge step may be employed to transition the gases from step A (508) to step B (510) or vice versa without intermixing the two process gases. The purge steps are not shown in FIG. 5. Step A (a) shown in FIG. 5 represents step A at the node a. Similarly, step B (a) represents step B at node a.

In some applications, particularly when etching high aspect ratio structures, an additional deposition step C (512) can be optionally included along with steps A and B. This step C is strategically inserted into the ALE cycle sequence but at a less frequent rate compared to steps A and B. Its primary function is to protect the sidewalls of the etched structures, thus preventing lateral etching that may arise due to the angular distribution of ion momentum. Step C (b) represents step C at the node b.

An ALE process runs in cycles, with each cycle including a step A and a step B. As shown in FIG. 5, an ALE cycle starts from a state and completes in another state. A state is denoted as 502, which describes the substrate undergoing processing. State a represents the state at the node a. Specifically, in an ALE process, the state describes one or multiple structures. The description of the states includes, but is not limited to, parameters describing a structure being etched, such as depth, critical dimensions, profiles, and loadings as shown exemplarily in Table 2. The state 502 is associated with a node 504. Hence, state a is associated with the node a. The ALE cycle starts initially at a node with a state, executes an action, denoted as 506, by selecting process recipe parameters using a policy neural network and MCTS program, and completes at another node with an updated state. In FIG. 5, action (a) denotes the action triggered by the ALE recipe at the node a.

It should be noted that a node can lead to more than one node through different actions. If the recipe parameters are continuous, the available new nodes would be infinite. Conversely, if the recipe parameters are discretized to limited levels, the available new nodes will be limited.

An ALE cycle is used for an action in FIG. 5 as an example only. In some other implementations, a half cycle can be employed to separate the nodes. In such a case, the action is either a surface modification step A, a sputtering step B, or even a deposition step C. All such variations will fall within the scope of the present inventive concept.

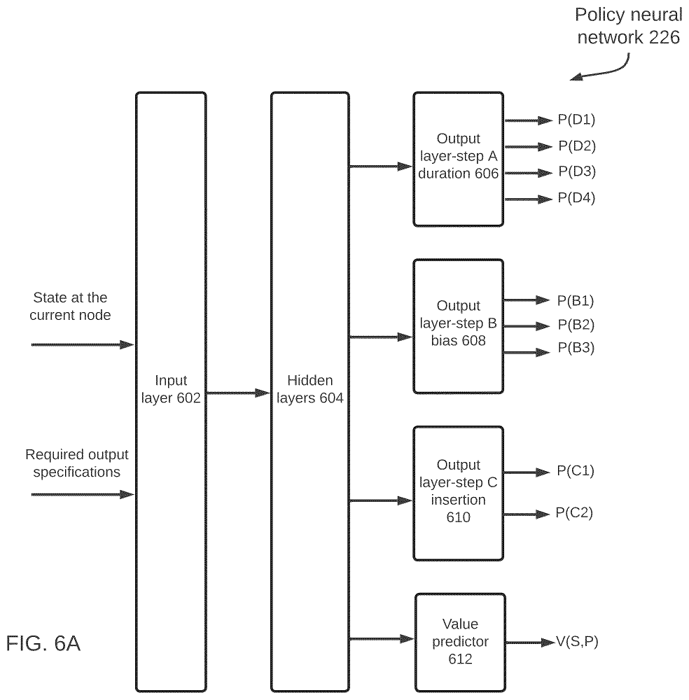

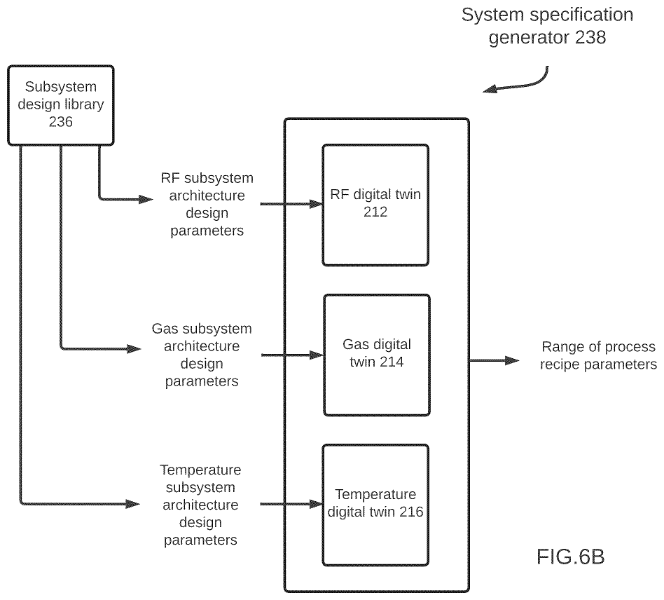

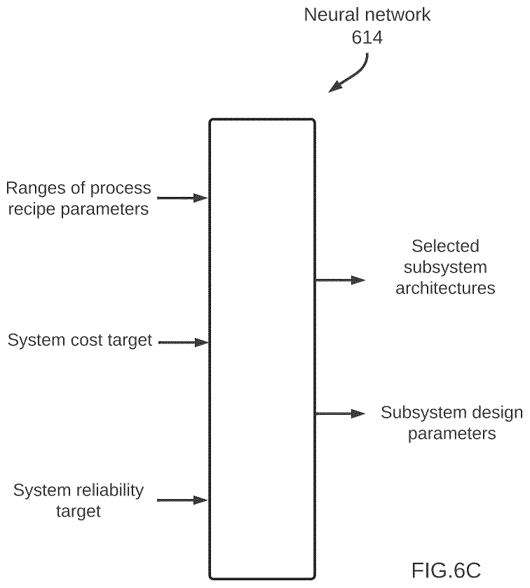

FIG. 6A showcases an exemplary policy neural network 226. The network 226 comprises an input layer 602 for receiving the state of the current node and required output specifications as its inputs. It should be noted that the output specifications herein are final requirements after completion of the entire process, not a step of the process. Inclusion of the output specifications as one of the inputs of the policy neural network 226 makes it more generic and able to deal with changes in output specifications. In some other implementations, the inputs include only the state.

The policy neural network 226 further includes one or more hidden layers, denoted as 604, for processing received data from the input layer 602. The policy neural network 226 further comprises an output layer which may include multiple parts, each part further includes several parameters describing softmax or logistic functions. The parts of the output layer are depicted in FIG. 6A as 606, 608, and 610 exemplarily, each delivering a probability distribution of a discretized process recipe parameter with more than one level. Furthermore, the output layer includes a value predictor 612 for predicting the value of the state based on the current policy represented by the policy neural network 226 with the current weights. When the policy neural network 226 is employed for designing the process system, the discretized levels for the recipe parameter should include limits of the parameter. Intrinsic capabilities of the process system will need to be evaluated against the limits, defined by the ranges of the parameters.

FIG. 6A exemplifies the ALE process, wherein three recipe parameters are selected. The first part 606 delivers probability distributions of 4 levels of the duration of step A, denoted as D1, D2, D3, and D4, where P(D1), P(D2), P(D3), and P(D4) are the probabilities of each level, respectively. A softmax function can be utilized to describe such 4-level probability distribution with 4 output parameters of the part. The probability can then be calculated accordingly. Similarly, the second part 608 outputs probability distributions of 3 levels of the chuck bias of step B. The third part 610 delivers probability distributions of 2 possibilities for either including or excluding a step C after step B in the ALE cycle. The two-level probability distribution can be represented by a logistic function. Exemplary ALE recipe parameters for this implementation are depicted in Table 3. The exemplary input parameters are listed in Table 2.

It should be noted that different sets of ALE recipe parameters may be selected, and different levels may be selected for each parameter. If the process system 100 is employed for a different type of process like deposition, the parameter selection may be different. The example herein is for illustration purposes and should not be considered a limit for the inventive concept. Furthermore, the selection of the recipe parameters and levels may be dynamic. It means they may be modified during the execution of an RL algorithm. In one implementation, after a predetermined number of simulated cases are executed, the RL agent 224 may decide to narrow down the parameter space and adjust ranges and levels of the parameters to accelerate the convergence of the RL algorithm. In some implementations, old parameters may be removed, and new parameters may be added. In still some other implementations, the entire set of recipe parameters may be selected and determined through the execution of the RL algorithm. The ranges of the parameters are related to subsystem capability and capacity and are stored in the storage medium of the compute engine 202 of the AI engine 200.

FIG. 6B depicts a schematic representation of a system specification generator 238. The system specifications include but are not limited to descriptions of the capabilities of the process system. In the context of the present inventive concept, the system specifications are represented by a process recipe which comprises a chain of actions to transform a substrate from a starting state to a terminal state which satisfies output specifications of a substrate after being processed in the vacuum process chamber. Ranges of the recipe parameters are indications of the capabilities of the process system. For example, the RF subsystem of the process system 100 may deliver the RF power from 500 to 5000 watts at 13.56 MHz at a delivery efficiency higher than 90%. The range from 500 to 5000 watts is a system specification. More generically, the system specification generator 238 takes subsystem architecture and design parameters as its inputs and ranges of the process recipe parameters as its output. The subsystem and system digital twins can be employed to process the input data and generate the output data. The input data is associated with a specific subsystem architecture. For example, the number of holes and the size of the holes are design parameters for a specific gas distribution unit like a showerhead or an injector. When a subsystem design is fixed for a test, the range of the recipe parameters is also fixed, determined by the capabilities of the subsystems and their integration. For example, the RF power range mentioned above is determined after the RF power amplifier circuit is constructed with various components like transistors, resistors, inductors, and capacitors. The range of the delivered power can be changed by either changing the value of the components or changing the architecture of the circuit. Each subsystem needs to meet its design target, which collectively determines the system specifications. The subsystem capabilities can be generated by utilizing the subsystem specification generator 234. The integration of subsystems together may create certain limitations for the subsystem outputs. For example, the RF subsystem may be able to deliver higher RF power than 5000 watts, but the heat dissipation of the gas distribution unit may prevent the power from reaching that level because of potential reliability issues. The system specification generator 238 should be able to capture the capabilities of the subsystems and the limitations imposed by the integration.

In some implementations, the architecture options of the subsystems can be stored in the subsystem design library 236. For example, it may include digital twins of various RF power generators possessing different ranges for the RF power at possibly different RF frequencies. The RF power generators may be supplied by different manufacturers. For the gas subsystem, the design library may include different types of vacuum pumps, from rough pumps to turbomolecular pumps with different capacities and ranges. In another example, the design library 236 may include a list of resonators tuned to different resonating frequencies at different operating power levels. It may further include various designs of RF power amplifiers with different components and architectures.

FIG. 6C showcases a neural network, denoted as 614. The neural network takes three inputs: the first input is the ranges of the process recipe parameters. The second input is targeted process system cost, and the third input is the process system reliability target. The network 614 generates selected subsystem architectures and subsystem design parameters associated with the architectures as its outputs. The neural network 614 can be trained by the simulation data generated from the system specification generator 238. In some implementations, the training may be enhanced by real-world measurement data.

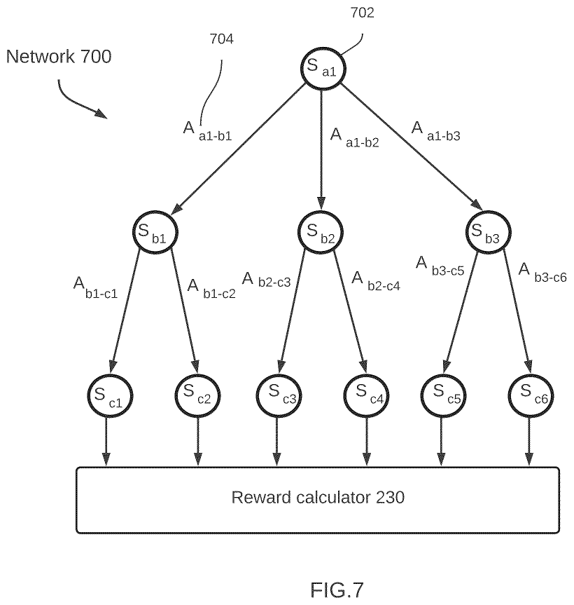

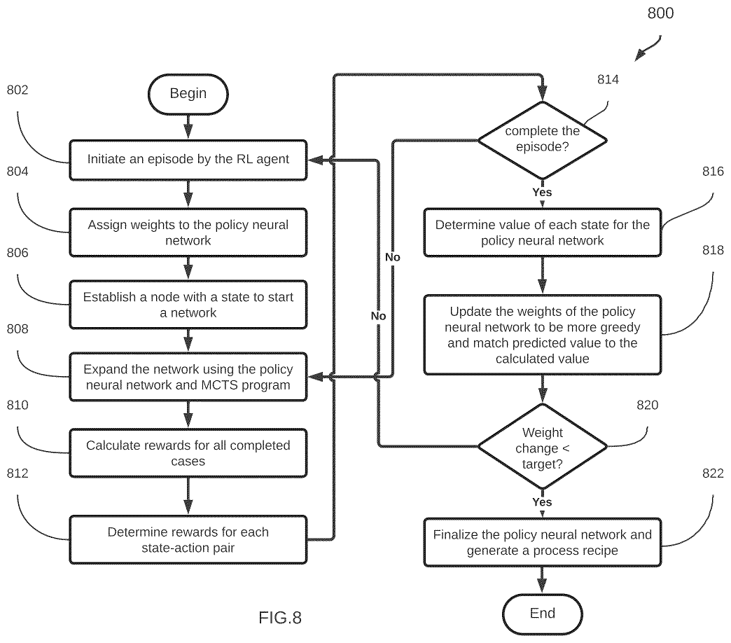

FIG. 7 schematically reveals a network 700 resulting from RL process being rolled out through the MCTS algorithm. As shown in FIG. 7, nodes like node 702 are represented by circles. Each node is associated with a state, such as Sₐ₁ in the cycle. A parent node can lead to multiple child nodes upon the execution of an action like 704. For example, the node with the state Sₐ₁ can transit into a node with the state S_{b1} resulting from the action A_{a1-b1}. The RL agent 224 manages the selection process through the policy neural network 226 and the MCTS program 228. For the ALE process, each action represents exemplarily one ALE cycle with selected process recipe parameters although a half cycle could also be an option. The selection of an action continues until reaching a terminal state where criteria are met to calculate a reward by a reward calculator 230. For example, in the case of an ALE process, the reward may be calculated when a specific etching depth is reached.

A reward can be designed based on a cost function. A cost function for the ALE process is typically formulated as a square function pertaining to each output parameter of the structure post the ALE processing. The cost function can be defined as:

$$c = {\sum }_{i = 1}^{N} {{w}_{i} ( {p}_{i} - {p}_{itarget} )}^{2} , \qquad [ 1 ]$$

where c is the cost, wᵢ is the weight, and pᵢ is a normalized output parameter like critical dimension at a selected vertical coordinate, p_{itarget} is the normalized target value of the output parameter, and N is serial number of the parameter. If multiple structures are evaluated, the cost function can be further expressed as:

$$C = {\sum }_{j = 1}^{M} {W}_{j} {c}_{j} , \qquad [ 2 ]$$

where C is the accumulated cost across multiple structures, Wⱼ is the weight, and cⱼ is the cost for one structure. The method can take several or many structures across a substrate like a 300 mm wafer. The method can further take different structures or different parts of the structure to quantify various loading effects. A reward can be designed as:

$$R = f ( c ) , \qquad [ 3 ]$$

Where R is the reward, and ƒ is a function for determining the reward based on the cost c. In one implementation, the reward may be designed as multiple, or many discrete numbers based on the cost. For example, the range of the cost can be divided into 10 intervals. Each interval is represented by an integer.

Each time the RL process reaches the terminal node, the reward can be computed. Each state-action pair like (Sₐ₁, A_{a1-b1}), which is a part of state-action chain for the test case to receive the reward. A visit count for the pair will also be updated. After enough test cases are executed and an episode is completed, the average reward associated with each state-action pair can be calculated as the accumulated reward divided by the visit counts.

The value associated with a node can then be calculated by averaging the reward across all state-action pairs originating from the node. These data can be employed to train the policy neural network 226 to be more focused on generating actions with higher rewards.

In some implementations, the RL algorithm can be designed to be biased toward exploration rather than exploitation. For example, in a new episode for RL, the initial weights for the policy neural network can be assigned randomly. This can be a useful technique to prevent the RL process from being trapped in a local optimal point in the process recipe parameter space.

In other implementations, techniques like the e-greedy algorithm may be employed to expand the search tree. The algorithm allocates a part of the probability distribution to a completely random distribution and is well known in the art.

The ALE example herein is for illustration only. For a real RL process, the number of nodes could be huge. The weights will be updated continuously to narrow down the selection of actions until the policy neural network 226 becomes deterministic. Subsequently, a process recipe can be generated for real-world applications.

FIG. 8 showcases a flowchart for a process 800, which is a self-initiated process for autonomously generating a process recipe through an RL process. Process 800 starts with step 802, where the RL agent 224 initiates an episode for the RL process. An episode is represented by a network consisting of many nodes created by the MCTS program enabled by the policy neural network. Each episode comprises many cases, wherein each case represents a completed simulation for a virtual process based on the system digital twin. For example, a case for an ALE process yields a completed ALE process. The structures on the substrate have met a set of criteria, such as reaching the targeted etching depth. This typically includes a chain of actions and multiple or many intermediate states. A completed episode should deliver the rewards associated with state-action pairs and the value of the nodes.

In step 804, initial weights are assigned to the policy neural network. In one implementation, the weights are assigned randomly. In another implementation, the weights are based on a previous RL episode, enabling continuous improvement which makes the policy neural network 226 generate more optimal actions to increase reward.

In step 806, an initial node for a network is established. The initial node is associated with an initial state which describes an incoming substrate with a set of parameters as listed exemplarily in Table 2. At this point in time, the RL agent 224 applies the policy neural network 226 to generate probability distributions of selected recipe parameters. Based on the probability distribution, the MCTS program 228 is employed to generate an action with determined recipe parameters. A random number generator is typically applied based on the distribution to generate the action. Subsequently, the RL agent 224 applies the action by leveraging the system digital twin 204 to generate the next node with a new state. The process repeats until a case is completed.

In step 808, the network is expanded progressively using the policy neural network 226 and the MCTS program 228. Each state-action pair of the network is associated with a visit count. Some state-action pairs are involved in more than one case, which is accounted for by the visit count.

In step 810, rewards are calculated based on the reward calculator 230 for all completed cases. If the state-action pair is involved in a specific case, it will receive the reward accordingly in step 812. The reward accumulates as the visit count is increased. The average reward for a specific state-action pair is the accumulated rewards divided by the visit count of the state-action pair.

In step 814, the RL agent 224 judges if the episode is completed. A decision may be made by evaluating nodes in the network and completed cases against selected recipe parameters/discrete levels. If the result is negative, the RL agent 224 continues to expand the network. Otherwise, the RL agent 224 determines the value for each state in step 816. For each node associated with the state, the RL agent 224 has established relationships between state-action pairs and their associated rewards. The value of the node based on the current policy neural network can be computed as an average of the reward across all the state-action pairs originated from the node.

In step 818, the RL agent 224 updates the weights of the policy neural network 226 based on all available state-action pairs. At each node, the state is an input for the policy neural network 226, and a set of softmax/logistic function parameters are the outputs. The output also includes the predicted value. The updated weights should make the policy neural network more focused on generating actions with higher value and predicting the value more accurately. As the policy neural network 226 improves, it should become more deterministic in selecting an action from a group of available actions to generate the highest reward. This becomes a typical classification problem, hence a cost function for updating the policy neural network 226 should include a cross-entropy loss function and a squared error for the value. The policy neural network 226 can be trained by leveraging rewards associated with all actions from the node. In one implementation, the earlier nodes may carry heavier weight during training to be consistent with a discount rule.

In step 820, the RL agent 224 evaluates if the weights have converged to give a deterministic policy neural network. If the result is negative, the RL agent 224 can initiate a new episode to repeat the process and generate more data through more exploration. In one implementation, an ¿-greedy algorithm may be employed to encourage exploration against exploitation. In another implementation, a new set of initial weights for the policy neural network 226 may be applied. In yet another implementation, the weights generated from the previous episode may be used together with the &-greedy algorithm.

If the evaluation in step 820 is positive, the policy neural network 226 is finalized in step 822. A process recipe can be generated accordingly. The generated recipe can then be deployed to substrate processing in a real-world process system.

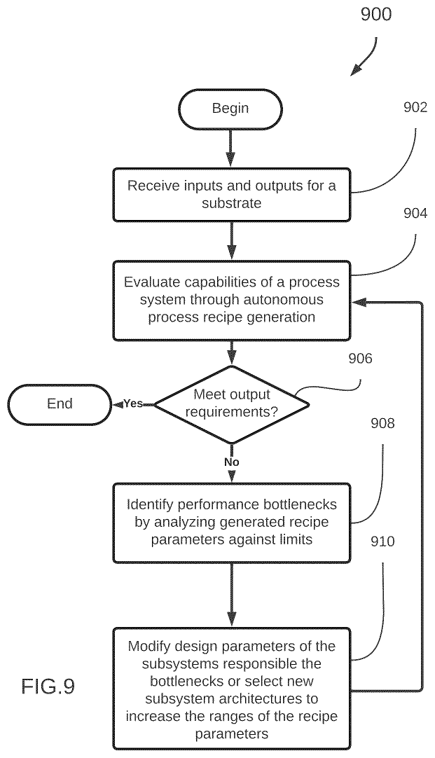

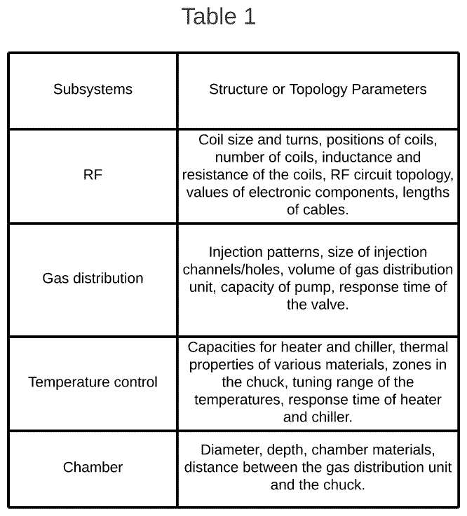

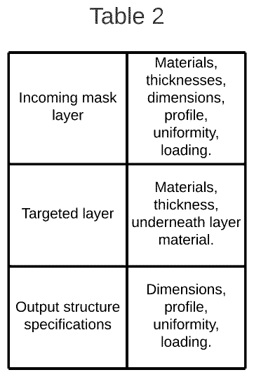

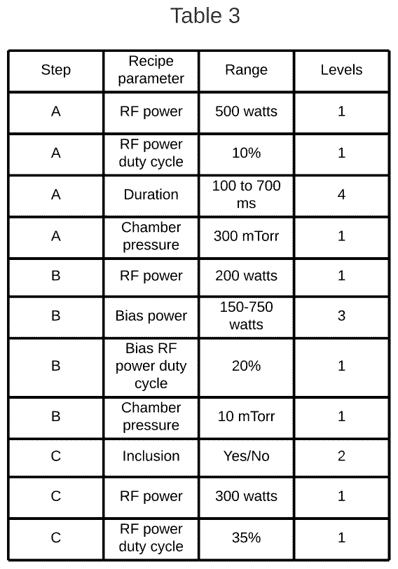

FIG. 9 illustrates a flowchart for an exemplary process for the design agent 232 to design a process system through working collaboratively with the RL agent 224 by leveraging the system digital twin 204. Process 900 starts with step 902 where the AI engine 200 receives inputs and outputs of a substrate to be processed using the process system 100. An example of the input and the output parameters for an ALE process is depicted in Table 2. In step 904, the RL agent 224 attempts to generate a process recipe by executing the RL process based on the system digital twin 204. The process system herein can be an established process system or an initial design of a new process system. In step 904, the capabilities of the process system are evaluated by the RL agent 224 and the design agent 232 jointly. The RL agent 224 searches for a solution in a large process recipe parameter space. The RL algorithm in this context will be designed to encourage exploration rather than exploitation. For example, the e-greedy algorithm may be adopted. In step 906, the design agent 232 will decide to end the RL process if a solution can be found based on the current process system. If the result is negative, the design agent 232 analyzes the generated best process recipe and identifies performance bottlenecks. The design agent 232 will pay special attention to the recipe parameters reaching their limits. In step 910, the design agent 232 modifies the design parameters of the subsystems responsible for the bottlenecks. In one implementation, the neural network 614 may be employed to conduct the job. Alternatively, a new architecture of one or more subsystems may be selected to replace the current subsystem architecture to acquire stronger capabilities. For example, the bias unit of the chuck can be switched from an RF power generator to a tailored waveform generator to provide tighter angular distribution of the ions during the sputtering step of the ALE process. Processes 902 and 904 are subsequently repeated based on the improved design to see if a new process recipe can be generated based on RL to meet the output specifications. If the result is positive, the design process conducted by the design agent 232 and the RL agent 224 jointly is then completed.

Throughout this disclosure, a single process recipe for a process case has been employed exemplarily to illustrate the inventive concept. It should be noted that the intrinsic capabilities of a process system may need to be established by evaluating multiple process recipes for several process cases. The inventive concept can be readily extended to such scenarios where performance bottlenecks can be identified by investigating the process recipe parameters from multiple process recipes against their limits. When the subsystems are redesigned to mitigate such bottlenecks, the ranges of the process recipe parameters will need to be increased to meet the requirements of multiple process recipes concurrently. The reward function can be designed accordingly to reflect such a multiple process recipe scenario.

In some embodiments, the AI machine can be implemented as a functionality of a generic AI server. In other embodiments, the AI machine can be a dedicated machine specifically designed for designing the process systems. In some implementations, the AI machine is in the cloud. In other implementations, the AI machine is coupled to one or more process systems through communication links. In yet other implementations, the AI machine may provide dual functionalities for autonomously generating a process recipe and recommending design improvements.

All such variations in implementations fall within the scope of the present inventive concept.

1. An artificial intelligence (AI) machine, comprising:
a plurality of hardware and software modules optimized for AI applications; and
an AI engine built upon the hardware and the software modules for autonomously designing a process system, wherein the AI engine further comprises:
a system digital twin for the process system including a plurality of subsystem digital twins for simulating a substrate progression in a vacuum process chamber;
a reinforcement learning (RL) engine for autonomously generating a process recipe by leveraging a policy neural network and a Monte Carlo tree search (MCTS) program; and
a design engine for autonomously identifying performance bottlenecks and recommending design changes for subsystems responsible for the bottlenecks, wherein the design changes further include selecting different architectures and/or modifying design parameters for the responsible subsystems.

2. The AI machine of claim 1, wherein the AI engine further includes a compute engine for controlling operations of the AI engine.

3. The AI machine of claim 1, wherein the design engine further includes a system specification generator for identifying ranges of selected recipe parameters from subsystem architecture and design parameters.

4. The AI machine of claim 3, wherein a Monte Carlo simulation is utilized to identify the ranges based on data from the system digital twin.

5. The AI machine of claim 3, wherein the system specification generator further includes a neural network.

6. The AI machine of claim 1, wherein the design engine identifies the performance bottlenecks by analyzing generated recipe parameters against their limits defined by the ranges.

7. The AI machine of claim 1, wherein the design engine further includes a subsystem design library, wherein the library further comprises architecture options for subsystems.

8. The AI machine of claim 1, wherein the policy neural network of the RL engine includes an input layer, a plurality of hidden layers, and an output layer with parts describing softmax and/or logistic functions for probability distributions of selected process recipe parameters across a plurality of discretized levels.

9. The AI machine of claim 1, wherein the RL engine and the design engine further comprise software programs stored in a storage medium of the AI machine.

10. The AI machine of claim 1, wherein the hardware modules further include GPU and HBM, wherein the software module further includes CUDA.

11. The AI machine of claim 1, wherein the subsystem digital twins further include an RF subsystem digital twin, a gas subsystem digital twin, and a temperature subsystem digital twin.

12. The AI machine of claim 1, wherein the process system further includes an etching or a deposition process system.

13. A method for designing a process system for semiconductor manufacturing, comprising:
a) receiving inputs and outputs for a substrate by an AI engine of an AI machine;
b) evaluating capabilities of the process system by the AI engine through autonomous process recipe generation, wherein an RL agent explores a solution in a process recipe parameter space;
c) identifying performance bottlenecks by the AI engine if the solution cannot be found;
d) designing autonomously subsystems responsible for the bottlenecks to increase ranges of the process recipe parameters; and
e) repeating steps b) to d) until the solution is found.

14. The method of claim 13, wherein the step of evaluating the capabilities further includes employing a policy network and an MCTS program, wherein the policy neural network further includes an input layer, a plurality of hidden layers, and an output layer, wherein the output layer further includes outputs describing softmax and/or logistic functions for probability distributions of selected process recipe parameters across a plurality of discretized levels.

15. The method of claim 14, wherein the discretized levels further include levels at the limits of the ranges of the selected recipe parameters.

16. The method of claim 15, wherein the step of identifying the bottlenecks further includes analyzing the levels of selected recipe parameters against the limits after evaluating the capabilities.

17. The method of claim 13, wherein the method further includes generating the ranges of selected recipe parameters by leveraging a system digital twin.

18. The method of claim 13, wherein the method further includes generating design parameters for at least one subsystem to remove the bottlenecks.

19. The method of claim 18, wherein the method further includes selecting a new subsystem architecture from a subsystem library or generating the design parameters using a neural network based on increased ranges of the recipe parameters.

20. An AI engine for autonomously designing semiconductor process systems, comprising:
a system digital twin for the process system including a plurality of subsystem digital twins for simulating a substrate progression in a vacuum process chamber;
a reinforcement learning (RL) engine for autonomously generating a process recipe by leveraging a policy neural network and a Monte Carlo tree search (MCTS) program; and
a design engine for autonomously identifying performance bottlenecks and recommending design changes for subsystems responsible for the bottlenecks, wherein the design changes further include selecting different architectures and/or modifying design parameters for the responsible subsystems.
